(19) United States
(12) Patent Application Publication
(10) Pub. No.: US 2012/0315073 A1
(43) Pub. Date: Dec. 13, 2012

(54) COATING APPLICATOR AND METHOD OF USING THE SAME

(75) Inventors: Steven M. Spirko, Avon, OH (US); Brian A. Suter, Elyria, OH (US); Paul K. Metaxatos, Swampscott, MA (US)

(73) Assignee: THE SHERWIN-WILLIAMS COMPANY, Cleveland, OH (US)

(21) Appl. No.: 13/416,501

(22) Filed: Mar. 9, 2012

Related U.S. Application Data
(60) Provisional application No. 61/450,786, filed on Mar. 9, 2011.

(51) Int. Cl. B05C 1/00

(52) U.S. Cl. 401/17

(57) ABSTRACT

An applicator for applying a coating composition to a substrate is provided. The applicator includes a point applicator and a brush applicator connected to a body having a first reservoir containing a first coating composition. The applicator further includes a removable second reservoir containing a second coating composition. A second applicator is connected to the body for applying the second coating composition.

### CROSS REFERENCE TO RELATED APPLICATIONS

This application claims priority to U.S. Provisional Application Ser. No. 61/450,786 filed Mar. 9, 2011, the entirety of which is hereby incorporated by reference.

This invention generally relates to precision coating applicators and more particularly to precision coating applicators for repairing blemishes in coated substrates. More specifically, the invention relates to a single precision coating applicator device that holds both a color coating composition and a clearcoat composition.

Precision coating applicators are utilized for various purposes, including repairing blemishes in coated substrates, as well as adding intricate designs to substrates. Many conventional precision coating applicators utilize a small brush for applying the coating. Such applicators are desirable when applying a coating to a relatively broad area, such as a paint chip, however, when applying a coating to a narrow area, such as a scratch, the brush may not be accurate enough. More accurate coating applicators are known for applying coatings to narrow areas. Examples of such coating applicators are shown in U.S. Pat. No. 1,868,416 to Hill, U.S. Pat. No. 2,070,953 to Morgan, U.S. Pat. No. 5,783,254 to Maynard, U.S. Pat. No. 6,065,477 to Doo and U.S. Pat. Nos. 6,254,299 and 6,283,633 to Russo. The Hill, Morgan and Russo patents disclose applicators with sliding nibs for applying lacquer to automotive bodies, while the Maynard and Doo patents disclose applicators having needles or elongated tubes. In addition to the applicators disclosed in the foregoing patents, numerous commercial automotive touch-up paint applicators with sliding nibs have been sold in the U.S. since at least the late 1980's. Examples of such commercial automotive touch-up paint applicators include the KRYLON CAR COLOR and KRYLON TOUCH AND GO touch-up paint applicators sold by Borden in the late 1980's.

In addition, there are precision coating applicators that are easy to use for both narrow and broad areas. Such an applicator is disclosed in U.S. Pat. No. 6,776,548 to Gardner, which is incorporated herein by reference in its entirety. The present invention provides an improvement over the applicator device described in the Gardener patent.

The present invention is an applicator device for repairing a blemish in a paint film comprising a body having a first reservoir containing a first coating composition and a second removable reservoir containing a second coating composition. A dual applicator device is connected to the body in fluid communication with the first reservoir. The dual applicator device comprises a housing having a point applicator and a brush-type applicator, the brush-type applicator comprising a shaft extending into the first reservoir. The body further comprises a second brush-type applicator comprising a shaft extending into the second reservoir. The brush-type applicator may be selected from a brush comprising a plurality of bristles, a foam pad type applicator, or a sponge applicator.

In one useful embodiment of the invention, the second removable reservoir has a bulbous shape with a larger diameter than the rest of the body. The removable reservoir may also include a funnel for reducing spillage from the reservoir if the reservoir is removed when the applicator is held horizontally.

### BRIEF DESCRIPTION OF THE DRAWINGS

The features, aspects, and advantages of the present invention will become better understood with regard to the following description, appended claims, and accompanying drawings where:

FIG. 1 shows a coating applicator constructed in accordance with a first embodiment of the present invention;

FIG. 2 shows an exploded view of a coating applicator in accordance with the present invention;

FIG. 3 shows a second exploded view of a coating applicator in accordance with the present invention;

FIG. 4 shows a side view of the coating applicator in accordance with the present invention with a portion cut-away to show the interior thereof;

FIG. 5 shows a side view of the upper portion of the coating applicator in accordance with the present invention with a portion cut-away to show the interior thereof;

FIG. 6 shows a side view of the second removable reservoir in accordance with the present invention with a portion cut-away to show the interior thereof.

### DETAILED DESCRIPTION OF THE INVENTION

It should be noted that in the detailed description which follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

As used herein with regard to a particular coating or paint composition, the terms “dried appearance”, “dried color”, and “dried finish” shall respectively mean the appearance, color, and finish of the coating or paint composition when dried.

As used herein, the term “vehicle” shall mean any device or contrivance for carrying or conveying persons or objects, including automobiles, motorcycles, trucks, vans, sport utility vehicles (SUVs), farm equipment, trailers, trains, boats, and ships.

The present invention is directed to a coating applicator and a method of using the same to repair blemishes in coated substrates. The applicator is especially suited for repairing blemishes in vehicles, particularly commercially-available road vehicles that are manufactured in large quantities, such as automobiles, motorcycles, trucks, vans, and SUVs. Manufacturers typically produce such road vehicles in a finite number of paint colors. As a result, after-market paint manufacturers are able to provide touch-up paint matching or closely approximating the colors of most commercially-available road vehicles.

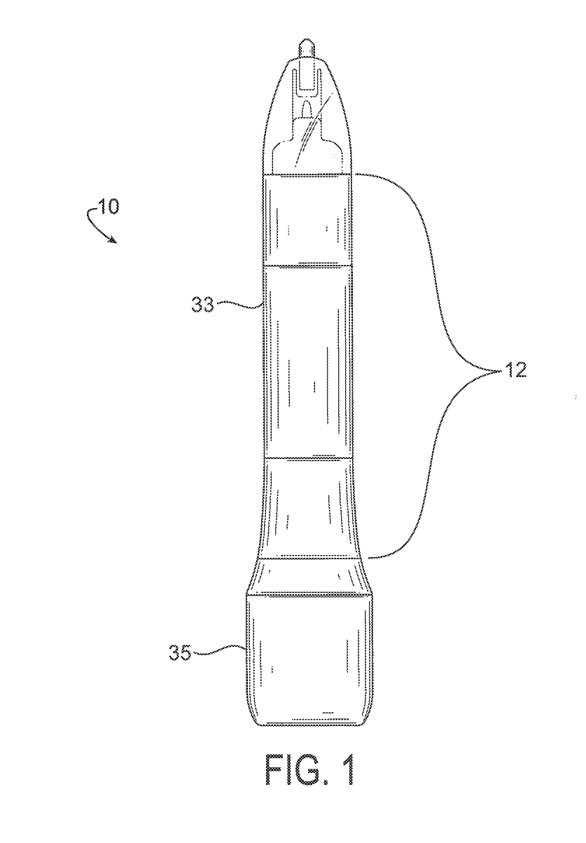

Referring now to FIGS. 1, 2 and 4, there is shown a coating applicator 10 embodied in accordance with the present invention. The coating applicator comprises a body 12 having a first reservoir 33. A second reservoir 35 is removably connected to the body. The reservoirs each may hold from about 0.125 fluid ounces to about 1 fluid ounce, for example from about 0.25 fluid ounces to about 0.5 fluid ounces.

A dual applicator head 14 having both a point applicator 16 and a brush applicator 18 is removably connected to the body and communicates with the first reservoir. The dual applicator head 14 is covered by a removable cap 20. In one useful embodiment, the cap 20 includes a scraping or cleaning tip 21. The scraping or cleaning tip may be made of fiberglass or other appropriate material and is used to clean out debris from scratches before the touch up paint is applied. A label (not shown) may be secured to the body.

The neck 30 of the first reservoir 33 portion of the body 12 is cylindrical and preferably has a diameter less than the diameter of the reservoir 33. An outer surface of the neck 30 has a helical thread 36 formed therein. A passage 38 extends through the neck 30, between an opening 32 in the top end wall 26 and the outer opening.

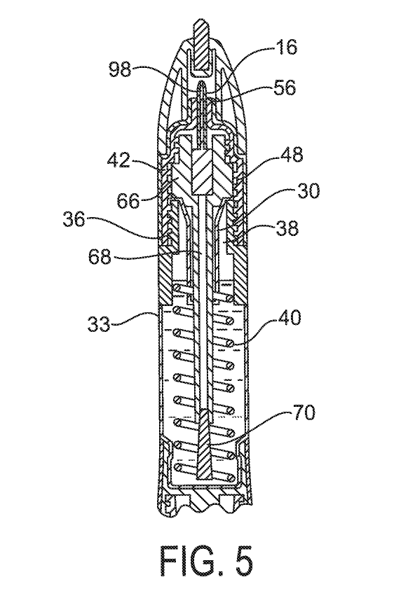

Referring to FIG. 5, an agitator 40 is disposed in the first reservoir 33. The agitator 40 is preferably a helical metal spring adapted to be reduced in diameter when one or both of the ends is/are twisted. More specifically, the agitator 40 is deformable between an expanded state, wherein the agitator 40 has a diameter greater than the passage 38 in the neck 30, but less than the diameter of the reservoir 33, and a contracted state, wherein the agitator 40 has a diameter less than the passage 38 in the neck 30. In this manner, the agitator 40 may be inserted into the reservoir 33 through the passage 38 when the agitator is in the contracted state. Once the agitator 40 is in the reservoir 33, the agitator 40 resiliently moves to its expanded state, which prevents the agitator 40 from being removed from the reservoir 33 through the neck 30. Since the agitator 40 in the expanded state has a diameter less than the reservoir 33, the agitator 40 is axially movable inside the reservoir 33. When the first coating applicator 10 is shaken, the axial movement of the agitator 40 helps mix the coating composition in the reservoir 33.

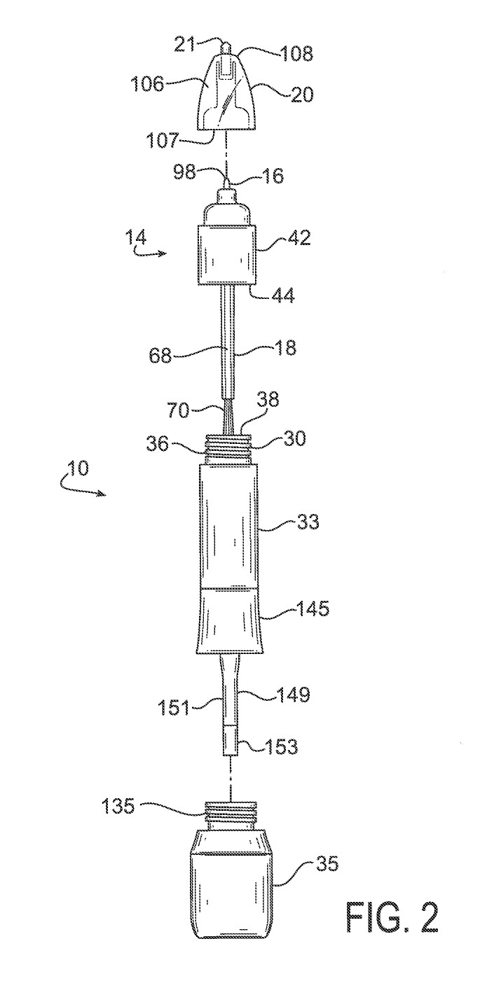

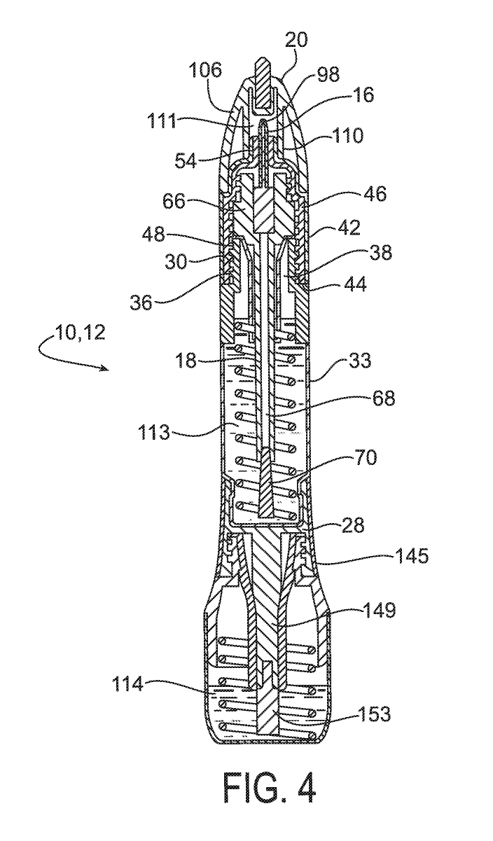

Referring now to FIGS. 2 and 4, the dual applicator head 14 includes a rigid housing 42 that is preferably composed of a hard plastic, such as high density polyethylene, or polypropylene. The housing 42 includes a base 44 having a cylindrical sidewall 46 with a helical thread 48 formed in an interior surface thereof. The thread 48 is adapted to mate with the thread 36 formed in the neck 30 of the body 12 to secure the applicator head 14 to the body 12.

The brush-type applicator 18 extends from the base 44 of the dual applicator head 14 and comprises a body 66 joined to a shaft 68 having a brush 70 extending therefrom. Preferably, the body 66 and the shaft 68 are integrally formed from a plastic that is sufficiently flexible to permit the shaft 68 to be flexed. An example of such a flexible plastic is low density polyethylene. The brush 70 may be comprised of a plurality of bristles and is configured to have a chisel shape. In alternative embodiments, the brush-type applicator may comprise other configurations such as pad made of foam or sponge material.

Referring now to FIGS. 4 and 5, there is shown a sectional view of the point applicator 16. The point applicator may comprise a roller ball applicator such as is described in U.S. Pat. No. 6,776,548 which is incorporated by reference herein. The point applicator may also be constructed to have a nib or tip 98 slidably disposed in the interior bore 56 of the housing 42. The nib may be a stylus, such as disclosed in U.S. Pat. No. 4,812,071 to Batra (which is hereby incorporated by reference), or a fiberous member such as disclosed in U.S. Pat. No. 3,377,124 to Matsumoto (which is hereby incorporated by reference).

Referring now to FIGS. 2 and 4, there is shown a sectional view of the cap 20. The cap 20 is composed of plastic, which may be clear or opaque. The cap 20 includes a side wall 106 having a first end defining an enlarged opening 107 and a second end closed by an end wall 108. Preferably, the side wall 106 is configured to facilitate being gripped by a user. Inside the cap 20, a tubular retaining sleeve 110 extends downwardly from an interior surface of the end wall 108. The sleeve 110 has an interior void 111 sized to snugly receive the tip portion 58 of the nozzle 54.

Referring now to FIG. 4, there is shown a sectional view of the first coating applicator 10 with the applicator head 14 secured to the body 12 and the cap 20 disposed over the nozzle 54 of the housing 42. The first brush-type applicator 18 extends into the first reservoir 33, with the brush 70 being disposed toward the bottom end wall 28. The base 44 of the housing 42 is secured to the neck 30 of the body 12 by the mating threads 36, 48 of the neck 30 and the base 44. The nozzle 54 of the housing 42 extends into the cap 20 through the enlarged opening 107.

The coating applicator 10 may be utilized to apply a coating composition 113 to a substrate using the brush applicator 18 and/or the point applicator 16. The coating composition 113 is disposed in the body 12, preferably in an amount sufficient for the coating composition 113 to extend above the brush 70 of the brush applicator 18.

When it is desired to use the brush-type applicator 18, the first coating applicator 10 is initially shaken to actuate the agitator 40 and mix the coating composition 113. The base 44 of the applicator head 14 is then unscrewed from the neck 30 of the body 12 and the brush applicator 18 is removed from the body 12, with any excess coating composition 113 being scraped off the brush 70 using the outer rim 34 of the neck 30. After the applicator head 14 is removed from the body 12 in the foregoing manner, the applicator head 14 is manipulated to move the brush 70 over the substrate to deposit the coating composition 113 on the substrate. Preferably, the cap 20 is maintained over the nozzle 54 while the applicator head 14 is being removed from the body 12 and manipulated to deposit the coating composition 113 on the substrate.

When it is desired to use the point applicator 116, the first coating applicator 10 is once again shaken to actuate the agitator 40 and mix the coating composition 113. The cap 20 is then removed from the nozzle 54 to expose the tip 98 of the point applicator 16. The first coating applicator 10 is preferably inverted or tilted to have the nozzle 54 and the tip 98 positioned downward, toward the substrate. The first coating applicator 10 is then moved downward to place the tip 98 in contact with the substrate. While applying a gentle downward force, the first coating applicator 10 is moved over the substrate. The coating composition flows around the point applicator and onto the substrate.

In one embodiment of the present invention, the coating composition 113 held in the first reservoir 33 is a touch-up paint composition formulated to have a dried appearance that corresponds to the appearance of a dried paint film on a commercially-available vehicle. More specifically, the touch-up paint composition is formulated with pigments and/or dyes to have a dried color that is the same or is substantially similar to the color of the vehicle paint film. This “color matching” may be performed with a spectrophotometer or colorimeter and preferably a computer, using known color matching processes. An example of color matching process that may be used is disclosed in U.S. Pat. No. 4,887,217 to Sherman, et al., which is assigned to the assignee of the present invention, and is hereby incorporated by reference.

Although the touch-up paint composition and the vehicle paint film have the same or substantially similar color, the touch-up paint composition may have a different formulation than the vehicle paint composition from which the vehicle paint film is derived. For example, the touch-up paint composition is typically a solvent-borne composition, while the vehicle paint composition may be a latex composition, or a non-aqueous dispersion.

Generally, the touch-up paint composition comprises a solvent carrier, a resin binder, and pigment. The solvent carrier typically comprises a mixture of organic solvents, such as methyl ethyl ketone, methyl isobutyl ketone, toluene, isopropyl alcohol, ethanol, and ethyl 3-ethoxy propionate. The resin binder typically comprises an acrylic resin or a vinyl-acrylic resin and nitrocellulose. The pigment includes one or more colorant pigments and an opacifying pigment, such as titanium dioxide. The pigment may also include metal flakes, such as aluminum and silver flakes.

The touch-up paint composition typically comprises from about 2 to about 8.5 weight percent pigment, based on the total weight of the touch-up paint composition. Total solids of the touch-up paint composition typically comprise from about 23 to about 31.5 weight percent of the total weight of the touch-up paint composition.

In another embodiment of the present invention, the coating composition 113 held in the body 12 is a touch-up primer composition for application over a metal and/or plastic substrate. The touch-up primer composition provides intercoat adhesion between the surface of the substrate and a decorative/protective base coat, such as a layer of the touch-up paint composition described above. The touch-up primer composition also fills in minor flaws in the surface of the substrate, which upon sanding, renders a smooth surface for application of the top coat.

Generally, the touch-up primer composition comprises a solvent carrier, a resin binder, and pigment. The solvent carrier typically comprises a mixture of organic solvents, such as methyl ethyl ketone, methyl isobutyl ketone, toluene, isopropyl alcohol, ethanol, and ethyl 3-ethoxy propionate. The resin binder typically comprises an oil-modified alkyd, such as a coconut oil modified alkyd resin, and nitrocellulose. The pigment includes an opacifying pigment, such as titanium dioxide, and typically a filler pigment, such as calcium carbonate. The pigment may also include a colorant pigment, such as carbon black. The pigment also preferably includes an anti-corrosion pigment for preventing the corrosion of metal substrates. Examples of such anti-corrosion pigments include zinc phosphate, zinc phospho oxide, strontium phosphate, zinc molybdate, zinc chromate, strontium chromate, barium chromate, and phosphosilicates. Preferably, the anti-corrosion pigment comprises zinc.

The touch-up primer composition typically comprises from about 17 to about 19.5 weight percent pigment, based on the total weight of the touch-up primer composition. Total solids of the touch-up primer composition typically comprise from about 34 to about 37 weight percent of the total weight of the touch-up primer composition.

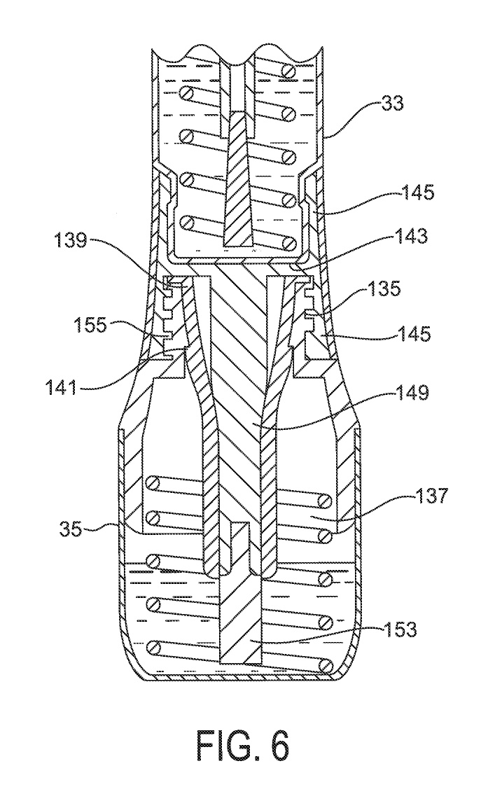

Referring now to FIGS. 2, 3 and 6, the body 12 further comprises a second, removable reservoir 35. In one useful embodiment, the second removable reservoir has a diameter that is greater than the rest of the body and may have a bulbous shape. The second removable reservoir has a neck 135 having helical threads. Inside the second removable reservoir 35 is a spring agitator 137 similar in operation and function to the spring agitator in the first reservoir 33. A funnel 139 may be included in the second removable reservoir to aid in preventing spillage of coating composition from the second removable reservoir in the event the removable reservoir is removed from the body when the applicator is in a horizontal position. The funnel 139 may frictionally engage steps 141 within the neck of the second removable reservoir to stay in place.

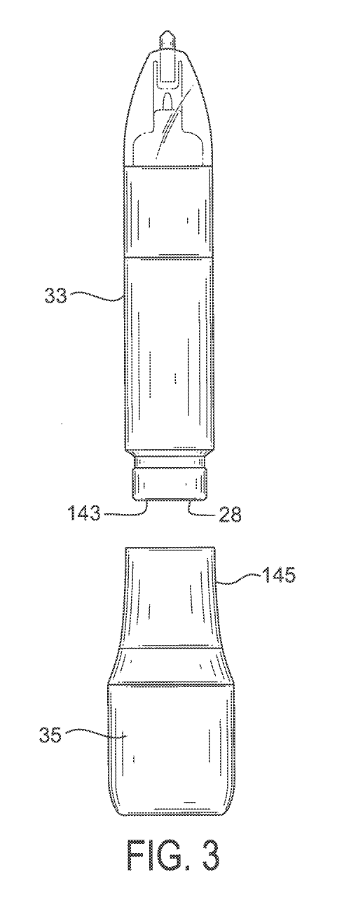

Referring now to FIGS. 2 and 3, the body 12, at the bottom of the first reservoir comprises a closed portion 143 configured to frictionally engage a second applicator housing 145. The top portion and inside of the second applicator housing are configured to engage the closed portion of the first reservoir 143 such that all of the pieces stay together during use. In one useful embodiment, the two pieces may snap together and are held together by cam action. Therefore, in one embodiment, the second applicator head is part of the body or is fixedly or permanently connected to the body. In an alternative embodiment, the second applicator head may be removably connected to the body.

The second applicator housing 145 includes a second brush-type applicator 149 comprising a shaft 151 and an applicator head 153. The applicator head 153 may be selected from the group consisting of brushes, foam, or sponge applicators. In one useful embodiment, where a foam or sponge applicator is used, the foam or sponge has a triangular or wedge shape to facilitate application of the coating composition.

The second applicator housing has an interior comprising helical threads 155 adapted to engage the threads 135 on the neck of the second removable reservoir (shown in FIG. 4).

The coating composition 114 held in the second removable reservoir 35 is a touch-up top coating composition for application over a base coat, such as a layer of the touch-up paint composition described above. The touch-up top coating is transparent and provides resistance to outdoor weathering, enhances the depth of color of the base coat, and provides a smooth and glossy finish.

Generally, the touch-up top coating composition comprises a solvent carrier and a resin binder. The touch-up top coating composition is typically free, or substantially free, of pigment. The solvent carrier typically comprises a mixture of organic solvents, such as methyl ethyl ketone, methyl isobutyl ketone, toluene, isopropyl alcohol, ethanol, and ethyl 3-ethoxy propionate. The resin binder typically comprises an acrylic resin or a vinyl-acrylic resin and a cellulose ester, such as cellulose acetate butyrate.

Total solids of the touch-up top coating composition typically comprise from about 28 to about 31 weight percent of the total weight of the touch-up top coating composition.

The viscosities of the touch-up paint composition, the touch-up primer composition and the touch-up top coating composition depend on the precise construction of the point applicator 16 and may be adjusted as required, using solvents, as is well known in the art.

If a base coating is to be used to repair the blemish, the base coating is selected to have a color that matches or closely approximates the color of the base layer of the paint film on the substrate. If a primer coating is to be used to repair the blemish, the primer coating is preferably selected to have a color that will provide good hiding when used in combination with the base coating.

In use of the present invention, once any debris have been removed from the blemish, the color coat housed in the first reservoir may be applied either by the point or brush-type applicator, followed by application of the clear coat from the second removable reservoir.

The coating applicator of the present invention is especially suited for applying touch-up coatings to vehicles, appliances, and machinery; however, the first and second coating applicators 10, 114 may also be used to apply nail polish to cuticles, or to apply correction fluid to documents.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. An applicator for repairing a blemish in a paint film on a vehicle, said applicator comprising:
a body comprising a first reservoir;
a first coating composition selected from (a) a primer composition comprising an anti-corrosion pigment and (b) a paint composition formulated to have a dried color that is substantially similar to the dried color of the paint film on the vehicle, wherein the first coating composition is held in the first reservoir;
a point applicator removably connected to the body to receive the first coating composition from the first reservoir;
a brush applicator removably connected to the body having a shaft with a plurality of bristles secured thereto, said shaft extending into the first reservoir;
a second reservoir, removably connected to the body;
a second coating composition comprising a transparent top coating composition, wherein the second coating composition is held in the second reservoir; and
a foam applicator connected to the body having a shaft with foam secured thereto, said shaft extending into the second reservoir.

2. The applicator of claim 1, wherein the second reservoir has a bulbous shape.

3. The applicator of claim 1, wherein the second reservoir has a diameter greater than that of the body.

4. The applicator of claim 3, further comprising a funnel disposed in the second reservoir for preventing spillage of the second coating composition when the second reservoir is removed from the body.

5. The applicator of claim 1, further comprising an agitator disposed in the first reservoir.

6. The applicator of claim 1, further comprising an agitator disposed in the second reservoir.

7. The applicator of claim 1, further comprising a cap positioned over the point applicator.

8. The applicator of claim 7, wherein the cap further comprises a tip extending outwardly from a top portion of the cap.

9. The applicator of claim 7, wherein the tip is made of fiberglass.

10. An applicator for repairing a blemish in a paint film on a vehicle, said applicator comprising:
a body comprising a first reservoir;
a first coating composition selected from (a) a primer composition comprising an anti-corrosion pigment and (b) a paint composition formulated to have a dried color that is substantially similar to the dried color of the paint film on the vehicle, wherein the first coating composition is held in the first reservoir;
a dual applicator head removably connected to the body, said dual applicator head comprising a housing having point applicator in fluid communication with said first reservoir and a brush-type applicator secured to a shaft extending into said first reservoir;
a second reservoir removably connected to the body;
a second coating composition comprising a transparent top coating composition, wherein the second coating composition is held in the second reservoir; and
wherein said body further comprises a second applicator head, said second applicator head comprising a brush-type applicator secured to a shaft extending into said second reservoir.

11. The applicator of claim 10, wherein the brush-type applicator of the dual applicator head is selected from a plurality of bristles, sponge, or foam.

12. The applicator of claim 10, wherein the brush-type applicator of the second applicator head is selected from a plurality of bristles, sponge, or foam.

13. The applicator of claim 10, wherein the second reservoir has a diameter greater than that of the body.

14. The applicator of claim 10, wherein the second applicator head is connected to said body by cam action.

15. The applicator of claim 14, further comprising a funnel secured in the second reservoir to prevent spillage of the second coating composition when the second reservoir is removed from the body.

16. The applicator of claim 10, wherein the first reservoir further comprises a neck having threads.

17. The applicator of claim 16, wherein the dual applicator further comprises threads adapted to engage the threads on the neck of the first reservoir.

18. The applicator of claim 10, wherein the second reservoir further comprises a neck having threads.

19. The applicator of claim 18, wherein the second applicator head comprises threads adapted to engage the threads on the neck of the first reservoir.

20. The applicator of claim 10, wherein the body comprises a closed portion at a bottom portion of the first reservoir and wherein such closed portion is configured to frictionally engage a top region of the second applicator head.
